(19) United States
(12) Patent Application Publication
(10) Pub. No.: US 2025/0269897 A1
(43) Pub. Date: Aug. 28, 2025

(54) Method for Waking up a Steering Control Unit

(71) Applicant: Robert Bosch GmbH, Stuttgart (DE)

(72) Inventors: Akm Nazmul Alam, Stuttgart (DE); Andreas Knoedler, Iggingen (DE); Markus Weber, Goeppingen (DE); Paul Lemmer, Goeggingen (DE); Senthilkumar Thulasidass, Schwaebisch Gmuend (DE)

(21) Appl. No.: 19/052,687

(22) Filed: Feb. 13, 2025

(30) Foreign Application Priority Data
Feb. 22, 2024 (DE) 10 2024 201 647.0

(51) Int. Cl. B62D 5/04

(52) U.S. Cl. CPC B62D 5/0481

(57) ABSTRACT

A method is disclosed of waking up a steering control unit including a controller and a motor in which a rotor position of a rotor of the motor is monitored and, in the event that a change in the rotor position is detected, the steering control unit is woken up.

This application claims priority under 35 U.S.C. § 119 to patent application no. DE 10 2024 201 647.0, filed on Feb. 22, 2024 in Germany, the disclosure of which is incorporated herein by reference in its entirety.

The disclosure relates to a method for waking up a steering control unit (SCU) and an assembly for carrying out the method.

### BACKGROUND

A steering control unit (SCU) typically comprises a controller and an electric motor. Such an SCU is typically used in an actuated steering or a power steering system in which a motor is used to apply an additional torque to assist in the steering movement. The controller of the SCU serves to calculate the steering assistance and to activate or control the electric motor using this information. The servo support is thus calculated in the controller. This calculation is performed not only as a function of the steering torque at the steering handle, for example a steering wheel, but also as a function of further vehicle parameters. The steering control unit also serves as an interface to other control devices of the vehicle.

In a steer-by-wire steering system, the steering control unit (SCU) must wake up during the parking state to block the steering wheel in the event that the steering wheel is moved by a person or a vibration, which results in the steering wheel not rotating freely.

In known methods, it is provided that the steering control unit is woken up in that the so-called back EMF voltage generated by the motor due to the steering wheel torque is monitored and sensed. Back-EMF is an electromotive force (EMF) that occurs when a motor rotates, in particular a brushless motor, rotates. The engine acts as a generator that generates an electromotive resistance.

When idle, a comparator monitors the back EMF voltage at a motor phase port compared to a voltage threshold. When the comparator outputs a high level signal or a high signal, the steering control unit wakes up.

Note that the back EMF voltage produced by the motor at low motor speed, e.g. less than 20 rpm, is very small and additionally is relatively inaccurate due to the motor tolerances.

In an automotive environment, environmental factors such as temperature, humidity, transients from the vehicle on-board network, EMC faults caused by adjacent electronic components or the traffic environment are furthermore expected. This superimposes an approximately equal interference voltage on a small back EMF voltage, which may have a wide frequency range and thus may not be able to be easily filtered out.

Thus, it is difficult to implement such a small voltage threshold and a hysteresis with tight tolerances for the comparator. The comparator switches either to the high level state or to high due to the noise or does not activate at all due to the high tolerance of the voltage threshold. This back EMF voltage-based wake up feature does not work reliably in all circumstances, specifically at low speeds, or a reliable solution would be disproportionately expensive.

Publication DE 10 2020 206 435 A1 describes a method for influencing movement of a steering handle of a steer-by-wire steering system in a vehicle. The steer-by-wire steering system comprises at least one feedback actuator for generating a steering resistance and/or a reset torque on the steering handle. In at least one operational state, in which the vehicle is in a stationary state and in a passive operating mode different from a normal driving mode, the feedback actuator is set and/or changed in response to an external force affecting the steering handling of the steering resistance and/or in response to the feedback actuator reset torque by way of a simulation function, such that a behavior of steering handling correlated to a drill and/or tire reset torque is simulated.

A protective device for a power steering system of a vehicle is known from publication DE 10 2006 040 689 B3. The power steering system comprises an electric servo motor associated with an evaluation circuit that, when ignition is off, registers a signal generated by rotation of the servo motor and activates a control and/or regulation device with an integrated braking function that decelerates the electric servo motor.

### SUMMARY

Given this background, a method and an assembly with the features set forth below will be presented. Embodiments arise from the description set forth below.

The method presented is for waking up a steering control unit (SCU) based on the absolute rotational angle of the rotor shaft of a motor, in particular a synchronous motor with permanent magnets. The steering control unit comprises a controller and a motor, and a rotor position of a rotor of the motor is monitored. For example, the situation or position of a rotor shaft of the rotor of the motor is monitored. In the event that a change in the rotor position is detected, the steering control unit is woken up.

In a steering controller, the servo assistance is calculated. This calculation is performed not only as a function of the steering torque at the steering handle, for example a steering wheel, but also as a function of further vehicle parameters. The steering control unit (SCU) also serves as an interface to other control devices of the vehicle. The SCU typically comprises a controller and an electric motor. The controller calculates the steering assistance and controls the electric motor using this information.

The method is based on the recognition that every rotor movement can be sensed by the rotor position sensor recording the rotor angle change. The system base chip is equipped with a rotor position sensor interface which can record the number of rotations of the rotors by using a counter in the sleep state. Each count corresponds to a change of 90° in the rotor position. A comparator monitors the counter. If the counter is incremented or decremented by 2 or more, i.e. a movement of 180° or more, the comparator goes too high and wakes up the system.

The method presented has, at least in some embodiments, a number of advantages:
unintended waking up may be prevented,
back EMF sensing in combination with rotor position sensing makes the SCU wake-up function more effective and reliable,
an SCU standby power request may be satisfied,
there is no additional implementation cost as this function is fully digital and uses the rotor position sensor which is already available in the system,
the method satisfies wake-up requirements for a number of applications such as a steering wheel actuator (SWA) and a steering rack actuator (SRA),
the wake-up function is independent of the type of engine and its BEMF (back EMF voltage) levels generated by the engine,

SPI (Serial Peripheral Interphase) configurability makes the method very flexible,
very slow movements can be sensed using the method.

The presented assembly comprises an evaluation unit that is configured to perform the method presented here. The assembly can be implemented in hardware and/or software. Furthermore, the assembly can be integrated into a controller of a vehicle or can be embodied as such. Furthermore, the assembly can be integrated into a controller of a steering control unit or can be embodied as such.

Further advantages and embodiments of the disclosure are shown in the description and the accompanying drawings.

It is understood that the abovementioned features and those to be explained below can be used not only in the combination indicated in each case, but also in other combinations or on their own, without departing from the scope of the present disclosure.

### BRIEF DESCRIPTION OF THE DRAWINGS

FIG. 1 shows an embodiment of the presented assembly in a block diagram.

FIG. 2 shows a flow chart of a possible sequence of the presented method.

FIG. 3 shows a schematic, highly simplified representation of a vehicle with an embodiment of the described assembly.

FIG. 4 shows a block diagram of a steering control unit.

### DETAILED DESCRIPTION

The disclosure is illustrated schematically by way of embodiments in the drawings and is described in detail below with reference to the drawings.

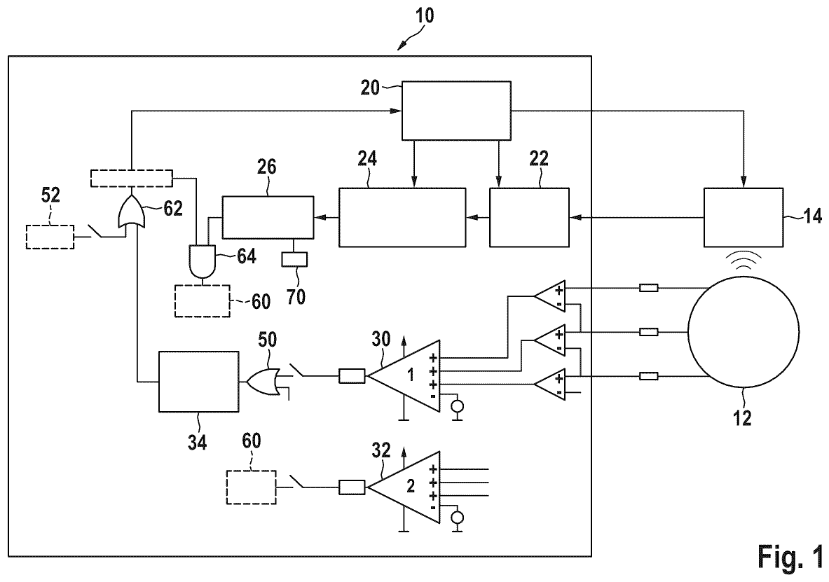

FIG. 1 shows a block diagram of an embodiment of the presented assembly, which is designated in total with reference numeral 10. The illustration further shows a motor 12 and a rotor position sensor 14. A sensor supply 20, a signal processing unit 22, a rotor position counter (SIN & COS) 24, a digital comparator 26, a first analog comparator 30, a second analog comparator 32 and a monostable tilt stage (retriggerable one shot) 34 are provided in the assembly. In this case, a trigger pulse sets the output to high. This high-state remains active for a fixed period of time, even if there is no input trigger signal. Each time the trigger pulse is switched on, the timer is restarted. Since the back EMF signal is transient, the output of comparator 30 is no longer kept constantly high by the signal itself. Instead, the monostable tilt stage 34 switches on the wake-up circuit 60 and the sensor supply for a fixed period of time for signal processing.

The input of the monostable tilt stage 34 is connected to the output of OR gate 50. A high is generated at the output of the OR gate 50, either by a high from analog comparator 30 or a high at the output of SIN/COS counter 24, which indicates a change in the counter reading. High at the output 50 in turn generates a high with a defined time at the output of the monostable tilt stage 34.

The output of the monostable tilt stage 34 is connected to an OR gate 62. The sensor may thus be woken up by either a back EMF signal or a periodic wake-up function.

The output of the OR gate 62 switches on the power supply to the sensor. This means that the sensor is supplied with energy and evaluated via the signal processing unit 22. Further, the rotor position via which the SIN/COS counter 24 is updated. The digital comparator 26 is set to high when the rotor position counter 24 matches a defined threshold in the comparison register 70.

The ASIC is woken up when the output of the OR gate 62 and the output of digital comparator 26 are high.

The method presented serves to wake up the SCU at a precise rotor speed, especially when the rotor speed is low, for example less than 20 rpm.

For this purpose, the rotor position counter 24 is provided, which is incremented or decremented by 1 for every 90° rotation of the rotor. Incrementing occurs when the rotor rotates clockwise, decrementing occurs when the rotor rotates counterclockwise. In the sleep state, the ASIC periodically ramps up the sensor supply and checks for any rotor movement and updates the counter when a rotor movement is sensed. If the ASIC senses a predetermined number of increments or decrements, which is configurable via the SPI, in the rotor position counter 24 during the sensor wake phases, the ASIC will fully awaken.

If the rotor rotates at a high speed, the ASIC will miss some rotor position count values and wake up at a later rotor position than the predetermined position. In that case, the conventional back EMF voltage sensing function will wake up the ASIC.

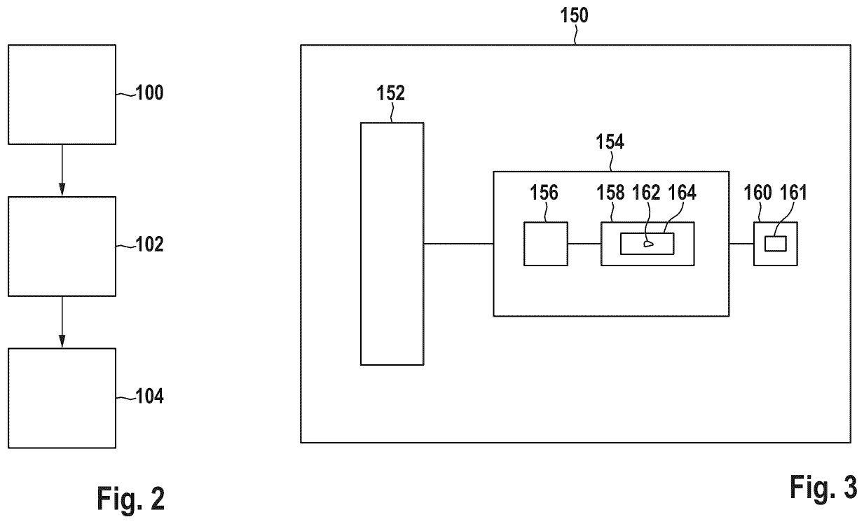

FIG. 2 describes a possible sequence of the presented method with a flowchart. In a first step 100, a steering controller of a steer-by-wire steering system of a vehicle is in a sleep state. The rotor position is monitored in this state. If a change of this rotor position is detected in a step 102 that is above a threshold value, then the steering control unit is woken up in a step 104.

FIG. 3 shows a schematic, highly simplified representation of a vehicle which is labeled overall with the reference number 150. This vehicle 150 comprises a steer-by-wire steering system 152 associated with a steering control unit 154, which in turn comprises a controller 156 and a motor 158. Further, an assembly 160 with an evaluation unit 161 is provided that monitors the rotor position of a rotor shaft 162 of a rotor 164 in the motor 158 and which is configured to wake up the steering control unit 154 in response to a detected change in position.

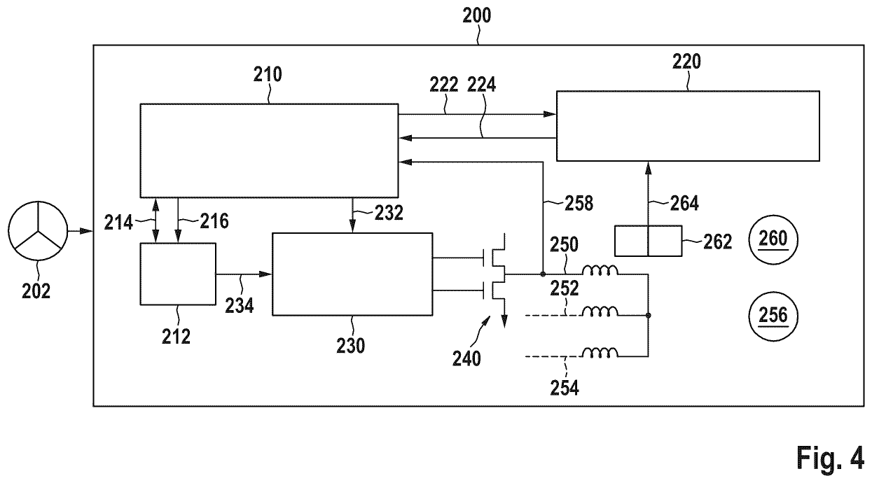

FIG. 4 shows a block diagram of a steering control unit, designated overall with reference numeral 200. This steering control unit 200 is connected to a steering wheel 202.

The illustration shows a system base chip 210 connected to a microcontroller 212 via an SPI interface 214 and a supply terminal 216. Further, a rotor position sensor 220 is provided, which in turn is connected to the system base chip 210 via a supply terminal 222 and a SIN/COS signal connection 224.

Further, a power amplifier driver 230 is provided, which is also connected to the system base chip 210 via a supply terminal 232 and to the microcontroller 212 via a signal connection 234. The power amplifier driver 230 controls the power amplifier switches 240 (a total of six), which in this case are MOSFETs, which in turn control the motor phases 250, 252, 254 of a motor 256. One or more connections of the motor phases 250, 252, 254, here return one or more signals for the back EMF voltage 258 to the system base chip 210.

A rotor 260 comprises a rotor magnet 262, which delivers an input signal 264 indicating the rotor position of the rotor 260 for the rotor position sensor 220.

What is claimed is:

1. A method of waking up a steering control unit that includes a controller and a motor, the method comprising:
monitoring a rotor position of a rotor of the motor; and
waking up the steering control unit in the event that a change in the rotor position is detected.

2. The method of claim 1, wherein waking up the steering control unit includes waking up the steering control unit when a time change of the rotor position is above a threshold value.

3. The method according to claim 2, wherein waking up the steering control unit further includes comparing the time change to the threshold value by way of at least one comparator.

4. The method according to claim 3, wherein the at least one comparator triggers the waking up of the steering control unit.

5. The method of claim 1, wherein a number of rotations of the rotor are counted with a counter.

6. The method of claim 1, wherein the method is performed in a permanently excited synchronous motor.

7. A method according to claim 1, wherein a back EMF voltage is additionally monitored to wake up the steering control unit, if necessary.

8. An assembly for waking up a steering control unit, comprising an evaluation unit which is configured to perform the method according to claim 1.

9. The assembly of claim 8, wherein the assembly is integrated in a system base chip.

10. The assembly of claim 8, wherein the assembly is configurable via a serial peripheral interface.
